(19) United States
(12) Patent Application Publication
(10) Pub. No.: US 2009/0248511 A1
(43) Pub. Date: Oct. 1, 2009

(54) ADVERTISEMENTS ON DEMAND

(75) Inventors: Satish Mehta, Fremont, CA (US); Srinivas Margasahayam, San Jose, CA (US)

Correspondence Address: MARTINE PENILLA & GENCARELLA, LLP, 710 LAKEWAY DRIVE, SUITE 200, SUNNYVALE, CA, 94085, US

(73) Assignee: Yahoo!, Inc., Sunnyvale, CA (US)

(21) Appl. No.: 12/060,145

(22) Filed: Mar. 31, 2008

(51) Int. Cl. G06Q 30/00; G06Q 10/00

(52) U.S. Cl. 705/14

(57) ABSTRACT

A method and system for providing advertisements on demand on a search results webpage includes receiving an ad preference for an advertisement through an user interface. The ad preference defines rendering option desired by an advertiser for the advertisement. A user preference for viewing an advertisement on the search results webpage is received through a user interface. An ad repository is searched to identify an advertisement that matches the ad preference with the user preference. The identified advertisement is rendered on the search results webpage along with search results in a format defined by the ad preference and user preference. The rendered advertisement allows optimal promotion of a product or service associated with the advertisement for an advertiser.

### BACKGROUND

1. Field of the Invention

The present invention relates to internet advertising, and more particularly, to providing advertisements on demand for optimal promotion of advertisements.

2. Description of the Related Art

With the growing popularity of internet commerce, advertisers and publishers are resorting to internet advertising for marketing their products and services. Internet advertising provides a flexible, low cost advertising tool to reach out to a global audience. For an advertiser or publisher, internet advertising gives the opportunity to precisely target their audience and to customize the advertisements based on a consumer's geographical region, interest, preference, taste, etc. Internet advertising also enables an advertiser or publisher to analyze the effectiveness of an advertisement by tracking user interaction with their advertisements. For a consumer, Internet advertising provides more direct interaction and provides easy and convenient access to wide array of products and services resulting in hassle-free shopping experience.

One form of internet advertising is Search engine marketing (SEM) wherein an advertiser tries to lure a consumer to the advertiser's website and hence, to the product or service offered by the advertiser, by strategically placing the advertisement in search results webpage for greater visibility. In order to place the advertisement in search results webpage, advertisers define their advertisements based on one or more keywords that they believe will be used by consumers searching for products/services similar to the ones offered by the advertisers. A consumer (user) looking for a certain product or service, uses the internet as a searching tool and enters one or more search parameters into a search engine. The search parameters include one or more search keywords defining search criteria of the user. The search engine searches the available inventory on the internet and returns a list of search results that match the entered search criteria. The search engine also searches an ad inventory to determine if the search keywords match keywords that define an advertisement. When a match of the keywords is found, the relevant advertisement will be included with search results for rendering on a search results webpage. These advertisements called “Sponsored links” or “sponsored advertisements” appear next to or above the search results on search results webpage, or anywhere an advertiser and/or search engine host chooses to place on the relevant content page. The revenue generated for the advertiser and search engine host are mostly through sponsored advertisements.

The sponsored advertisements are generally served in broadcast mode. In broadcast mode, one or more advertisements matching the search keyword(s) are rendered on a search result webpage for specific period of time. These advertisements are relevant to the search criteria. The advertisements may be banner advertisements or any other type of advertisements. In a banner advertisement, the advertisements are rendered either at top or bottom of a search webpage generally with a link to an advertiser's content or external website. The advertiser is able to determine the effectiveness of the advertisement by tracking advertising metrics, such as user interactions (for e.g. number of clicks) at the link provided in the advertisement. However, the advertising metrics may not provide an accurate picture of the effectiveness of the advertisement as some of the user interactions may be inadvertent or fraudulent. In such a case, the advertiser has no way of knowing the true intentions of the user. As a result, the conversion ratio between a user interaction (such as clicking) to revenue generation is very low. The advertiser may end up spending his/her advertising budget without realizing any tangible benefit from the advertisement.

Meanwhile, a user will be presented with a plurality of advertisements on a search results webpage that he/she may or may not want to view. The user does not have any control with the rendering of the advertisements. As a result, a user may be overwhelmed with the search experience due to inundation of information on the search results webpage.

It is in this context that embodiments of the invention arise.

### SUMMARY

Embodiments of the present invention provide methods and computer implemented systems that enable providing advertisements on demand on a search results webpage. The methods include obtaining an ad preference for an advertisement from an advertiser associated with the advertisement. The ad preference defines rendering option desired by an advertiser for the advertisement on the search results webpage. A user preference for viewing the advertisement is received from a user that defines viewing option desired by a user. The user preference may be received along with a plurality of search parameters that define search criteria for a product or service. An ad repository is searched to identify one or more advertisements that not only match the search criteria of the user but also match the user preference with the ad preference of each of the advertisements. The ad repository includes a plurality of advertisements from a plurality of advertisers. Each of the advertisements in the ad repository is stored along with a descriptive tag that uniquely identifies the ad preference defining the rendering option desired by the advertiser for the respective advertisements. The identified advertisements are rendered on the search results webpage along with a plurality of search results in a format defined by the ad preference and the user preference. The rendered advertisements provide optimal promotion of the product/service for the advertiser associated with the advertisement.

It should be appreciated that the present invention can be implemented in numerous ways, such as methods, apparatus or a system. Several inventive embodiments of the present invention are described below.

In one embodiment, a method for providing advertisement on demand on a search results webpage is disclosed. The method includes receiving an ad preference for the advertisement. The ad preference may be obtained from an advertiser associated with the advertisement. The ad preference defines rendering option desired by the advertiser for the advertisement. A user preference for viewing an advertisement on the search results webpage is received from a user. An ad repository having a plurality of advertisements from a plurality of advertisers is searched to identify and return an advertisement that matches the ad preference with the user preference. The identified advertisement that matches the user preference with the ad preference is rendered on the search results webpage along with a plurality of search results in a format defined by the ad preference and user preference. The rendered advertisement allows optimal promotion of the product/service for the advertiser associated with the advertisement.

In another embodiment, a method for providing an advertisement on demand on a search results webpage is disclosed. The method includes receiving a plurality of advertisement parameters for booking an advertisement, from an advertiser. The advertisement parameters define an advertiser's objective and include one or more keywords describing the advertisement. The advertisement parameters are used in booking the advertisement. In addition to the advertisement parameters, an ad preference is also obtained from the advertiser. The ad preference determines rendering option desired by the advertiser for the advertisement. The advertisement is booked using the advertisement parameters. A descriptive tag is defined to distinctly identify the ad preference for the advertisement. The descriptive tag is associated with the advertisement and stored in an ad repository along with the advertisement upon booking of the advertisement. The descriptive tag is used in mining the advertisement for rendering on a search results webpage based on a user preference.

In yet another embodiment, a method for providing an advertisement on demand on a search results webpage is disclosed. The method includes receiving a plurality of search parameters from a user. The search parameters define search criteria and include one or more search keywords. The search parameters are used to search for a product or service. A user preference is also obtained along with the search parameters. The user preference defines viewing option desired by a user to view an advertisement at a search results webpage. One or more search results matching the search criteria are identified from available inventory and returned for rendering on a search results webpage. One or more advertisements with keywords matching the one or more search keywords are identified from an ad repository. Each of the advertisements in the ad repository is tagged with a descriptive tag that distinctly defines an ad preference associated with the corresponding advertisement, during the booking of the advertisement. The identified advertisements are rendered on a search results webpage along with the plurality of search results in a format defined by the ad preference and user preference. The rendered advertisements allow optimal promotion of a product or service associated with the advertisement.

In yet another embodiment, a system for providing advertisements on demand on a search results webpage is disclosed. The system includes a user interface to receive and transmit a user preference for viewing an advertisement on the search results webpage and an ad preference defining rendering option desired by an advertiser for an advertisement associated with the advertiser. The system also includes server equipped with a search engine that is communicatively connected to the user interface to receive the user preference of a user and an ad preference for an advertisement. A tag generator at the server is configured to interact with the search engine to receive the ad preference, define and associate a descriptive tag distinctly defining the ad preference for that advertisement. An ad generator at the server interacts with an ad repository to identify one or more advertisements that not only match with the search criteria but also match the ad preference with the user preference and return the identified advertisements to the search engine. The search engine is configured to identify one or more search results from available inventory at the server that match the search criteria and return the search results along with the identified advertisements to the user interface for rendering. The identified advertisement is rendered with the search results on a search results webpage in a format defined by the ad preference and user preference. The rendered advertisements allow optimal promotion of a product or service associated with the advertisement.

Other aspects of the invention will become apparent from the following detailed description, taken in conjunction with the accompanying drawings, illustrating by way of example the principles of the invention.

### BRIEF DESCRIPTION OF THE DRAWINGS

The invention may best be understood by reference to the following description taken in conjunction with the accompanying drawings.

FIG. 1 illustrates a high-level block diagram of a system used in providing advertisement on demand on a search results webpage, in accordance with one embodiment.

FIG. 2 illustrates an overview of components of a system involved in providing advertisement on demand on a search results webpage, in accordance with one embodiment.

FIG. 3A illustrates a sample search results page with search results and sponsored advertisements rendered, in accordance with one embodiment.

FIG. 3B illustrates a sample search results page with search results rendered, in accordance with one embodiment.

FIG. 3C illustrates a sample search results page with sponsored advertisements rendered, in accordance with one embodiment of the invention.

FIG. 4 illustrates a flow chart of process operations involved in providing advertisements on demand in a search results webpage, in accordance with one embodiment of the invention.

FIG. 5 illustrates a flow chart of process operations involved in providing advertisements on demand in a search results webpage, in accordance with an alternate embodiment of the invention.

FIG. 6 illustrates a flow chart of process operations involved in providing advertisements on demand in a search results webpage, in accordance with an alternate embodiment of the invention.

### DETAILED DESCRIPTION

Broadly speaking, the embodiments of the present invention provide methods and computer implemented systems for providing advertisements on demand on search results webpage. A plurality of advertisement parameters associated with an advertisement is received through a user interface. The plurality of advertisement parameters defines advertisement objective of an advertiser and is used in booking the advertisement using one or more keywords. An ad preference for the advertisement is received from the advertiser along with the advertisement parameters. The ad preference identifies rendering option desired by the advertiser for the advertisement. A descriptive tag distinctly describing the ad preference is defined and associated with the advertisement. The descriptive tag is stored in an ad repository along with the advertisement for future mining.

A user preference identifying viewing option desired by the user for viewing advertisements on a search results webpage, is received from the user interface. The user preference is received along with a plurality of search parameters that define search criteria for a product or service. The search parameters, including one or more search keywords, are used to identify and return one or more search results from available inventory. The ad repository is searched to identify and return one or more advertisements with keywords that match the one or more search keywords, based on a matching of the ad preference associated with each advertisement with user preference. The identified advertisements are rendered on a search results page along with the identified search results in a format defined by the ad preference and user preference. The identifying and rendering of the advertisements allows for optimal promotion of a product or service for the advertiser associated with the advertisement.

Using ad preference, an advertiser is able to control when and what type of advertisement to render on a search results webpage. This allows the advertiser to maximize the return on advertisement budget as the advertisements are rendered only when the advertiser wants to render and a user desires to view the advertisement. Thus, the advertiser is able to realize better click-to-revenue conversion ratio as there is a high likelihood of a user interaction at the rendered advertisements. As the advertisements are rendered based upon user preference, potential fraudulent or inadvertent user interactions are averted. For a user, the embodiments of the invention provide a better control on when to include advertisement on the search results webpage thereby enriching the user's search experience. The user preference option provides for a more customized search results webpage with controls to activate or deactivate rendering of advertisements.

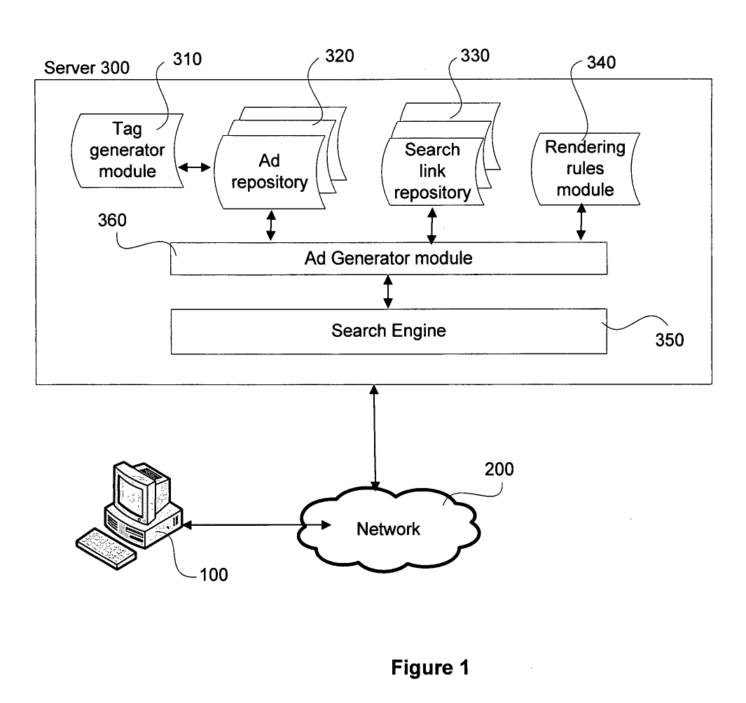

With the aforementioned general description of the invention, various embodiments of the invention will now be described in more detail. FIG. 1 illustrates a high-level block diagram of a system used in providing advertisement on demand on a search results webpage. The system includes a user interface 100 to receive and transmit a plurality of advertisement parameters and ad preference for an advertisement. The advertisement parameters define the advertisement objective of the advertisement and are used for booking the advertisement using one or more keywords. The user interface 100 is also used to receive and transmit one or more search parameters and user preference. The search parameters include one or more search keywords and are used in searching for a product or service. The user preference identifies the viewing option desired by a user for viewing advertisements.

A search engine 350 on a server 300 is configured to interact with the user interface 100 through a network 200, such as internet, to receive the advertisement parameters, ad preference for an advertisement, search parameters for a product or service and user preference. The search engine 350 uses the advertisement parameters for booking an advertisement using one or more keywords. A tag generator 310 available to the search engine 350 on the server 300 is configured to receive the ad preference and define a descriptive tag distinctly describing the rendering option identified by the ad preference. The descriptive tag is associated with the advertisement at the time of booking the advertisement. The advertisement and the descriptive tag are stored in an ad repository 320 available to the search engine 350 on the server 300, for future mining. The ad repository 320 houses a plurality of advertisements from a plurality of advertisers with each of the plurality of advertisements associated with a respective descriptive tag describing the ad preference associated with the respective advertisements. The ad repository 320 may be a single repository accessible to the search engine on the server 300 or may include a plurality of repositories available on the server 300 or on a plurality of servers with the search engine communicatively connected to each of the servers to access the advertisements and the associated descriptive tags. The search engine also includes a search link repository 330 to store a plurality of search result links. The search link repository 330 may, in turn, include a plurality of repositories distributed on the server 300 or across a plurality of servers with the search engine 350 having access to each of the search link repositories 330 for mining the search results.

In addition to the various repositories, the server 300 includes a rendering rules module 340 used for rendering of the advertisements on the search results webpage. The rendering rules module may include a set of pre-defined rules to determine where and how the advertisements are to be rendered on the search results webpage. In one embodiment, the rendering rules module 340 may include a rule to rank and prioritize a plurality of advertisements selected for inclusion on a search results webpage, based on a pre-defined ranking metric. The ranking metric may be used to determine the rendering sequence of the selected advertisements on the search results webpage. The rendering rules module 340 interacts with the ad repository 320 to rank and prioritize the identified advertisements for rendering on the search results webpage. The advertisements are rendered on the search results webpage based on the rules from the rendering rules module 340 and the user preference.

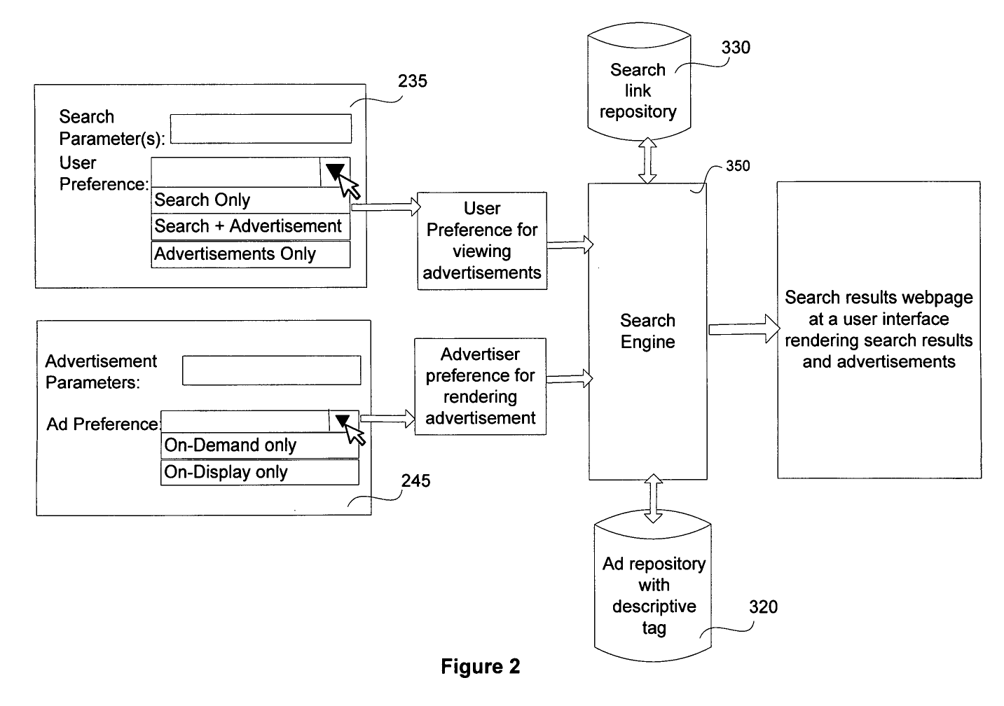

FIG. 2 illustrates an overview of the process operations involved in providing advertisements on demand on a search results webpage, in one embodiment of the invention. The process begins with an advertiser providing a plurality of advertisement parameters to book an advertisement for a product or service. The advertisement parameters are obtained through an ad interface webpage 245 at the user interface and define the objective of the advertiser. Along with the advertisement parameters, the advertiser provides an ad preference to define the rendering option desired by the advertiser for the advertisement. The rendering option available at ad interface webpage 245, for instance, may include an “On-Demand” option or an “On-Display” option. An advertisement with the on-demand option will be rendered only when explicitly requested by a user. On the other hand, an advertisement with the on-display option may be rendered as a default or when a user chooses to view advertisements along with search results. In the embodiment illustrated in FIG. 2, the ad preference is depicted as a drop-down menu box. The ad preference is not restricted to a drop-down menu box but can be extended to include other options such as radio-buttons, check-boxes, etc. The ad preference and advertisement parameters for the advertisement are transmitted to the search engine 350 on the server. The advertisement parameters, defining the objective of the advertiser, are used to book the advertisement using one or more keywords. The ad preference for the advertisement is used to define a descriptive tag that distinctly identifies the intent of the advertiser for rendering the advertisement. The descriptive tag is associated with the advertisement. The booked advertisement and the associated descriptive tag are stored in an ad repository 320 accessible to the search engine 350 for later mining. It should be noted that the booked advertisements may be classified as sponsored advertisements. A sponsored advertisement is one wherein the advertiser associates an advertisement budget for the advertisement and is used during the rendering of the advertisement on a webpage.

A plurality of search parameters is received from a user interface through a search interface webpage 235 available at the user interface. The search parameters define search criteria for a product or service and include one or more search keywords. The search parameters are used to search available inventory at the server to identify one or more search results that satisfy the search criteria. The search results are obtained by searching the available inventory to identify one or more search results that algorithmically match the search parameters. In addition to the search parameters, a user preference is also obtained from the search interface webpage 235. The user preference provides options that dictate the rendering content in a search results webpage. Some of the options for controlling the rendering content available at the search interface webpage 235 may include “Search only”, “Search and Advertisements”, or “Advertisements only.” When a “Search only” option is selected, only search results are rendered on the search results webpage. When a “Search and Advertisements” option is selected, search results and one or more sponsored advertisements are rendered on the search results webpage and when “Advertisements only” option is selected, only sponsored advertisements are rendered on the search results webpage. Thus, the user preference provides the control to determine what content is to be rendered on a search results webpage.

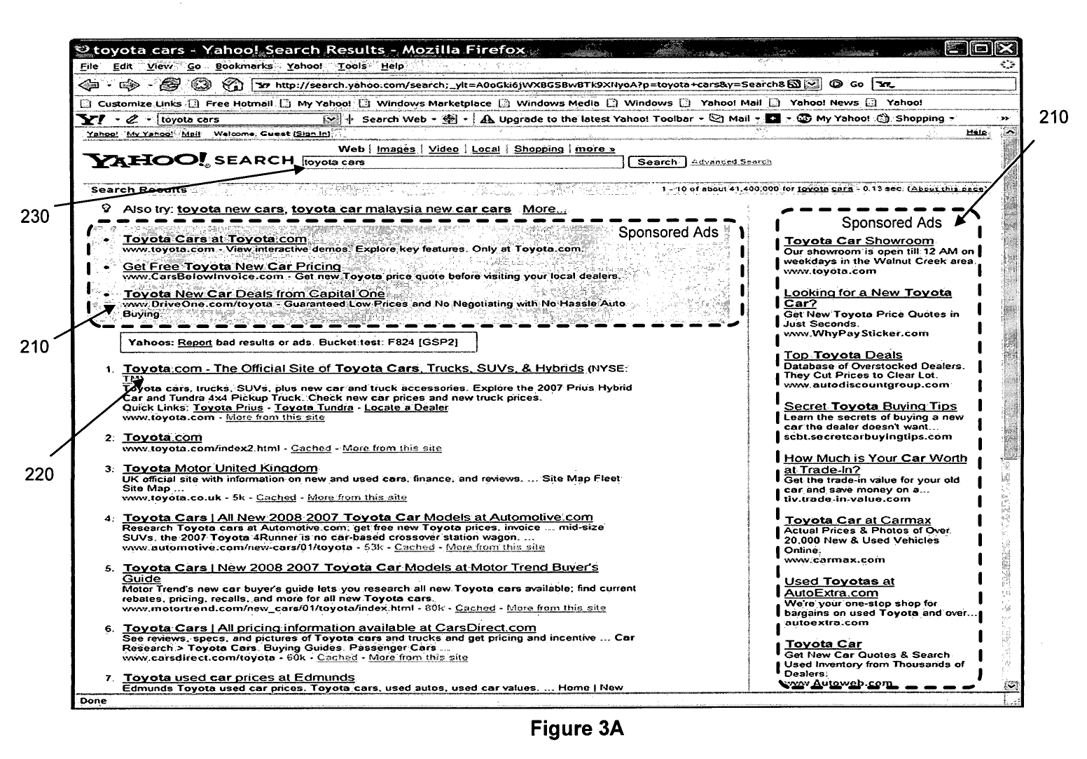

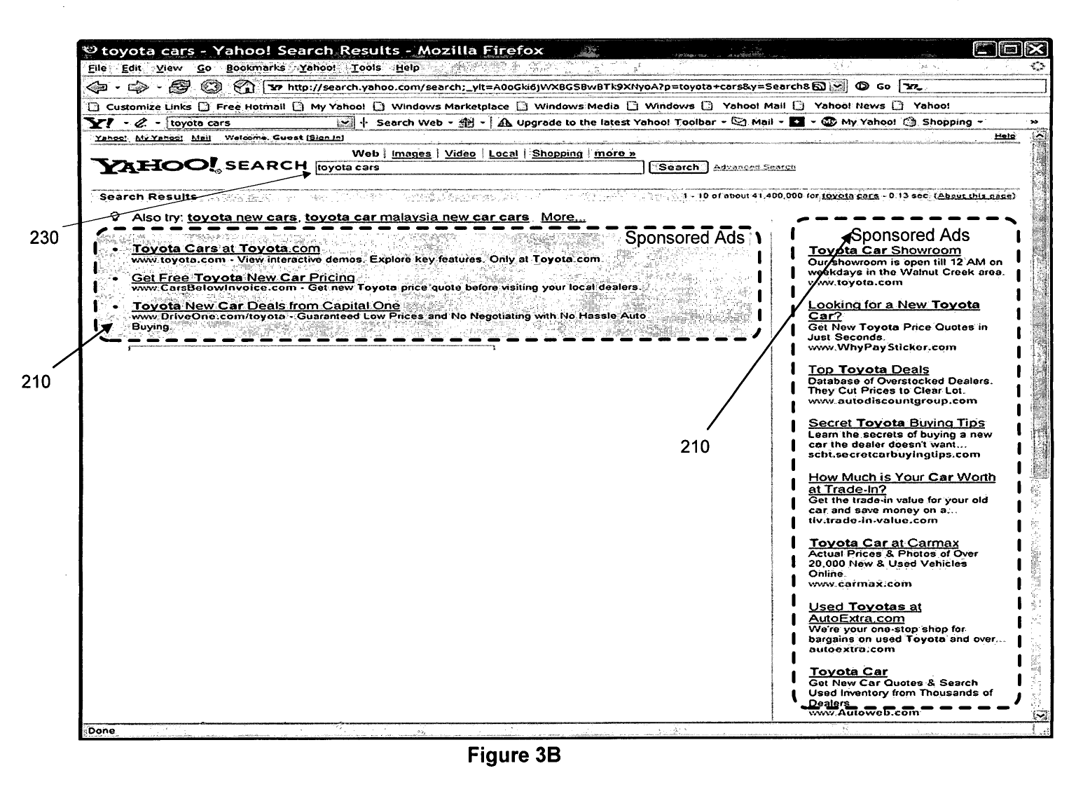

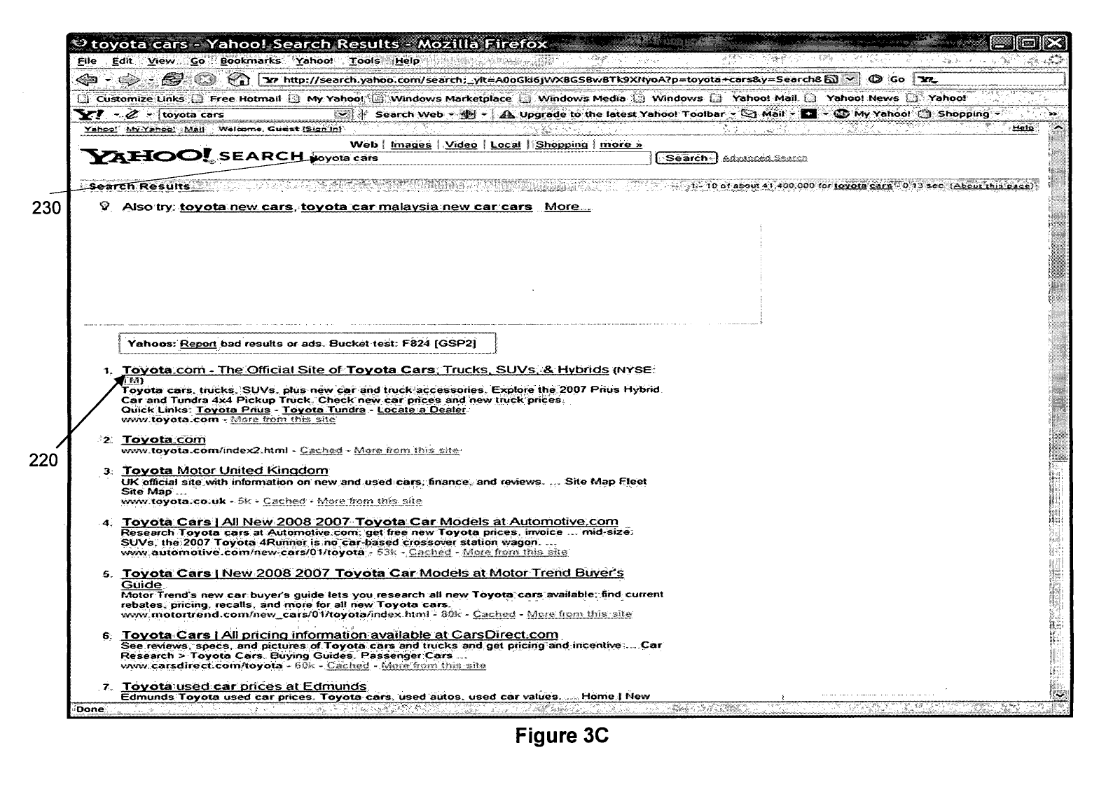

FIGS. 3A through 3C illustrate the search results webpage rendering the search results and associated advertisements based on user preference. FIG. 3A illustrates a search results webpage with sponsored advertisements 210 rendered along with a plurality of search results 220, in one embodiment of the invention. The search results 220 are obtained by matching one or more search parameters 230 provided at a user interface webpage 235 with available inventory, using a mathematical algorithm. The user preference, in this embodiment, specifies “Search and Advertisements” option. As the user option specifically requests for advertisements to be rendered along with search results, the search results webpage includes the sponsored advertisements that match the search parameters 230 along with search results. The ad preference for each of the advertisements will have to specify “ON-DISPLAY” option in order to be rendered on the search results webpage along with the search results. If an advertisement specifies an “ON-DEMAND” option, then that advertisement will be filtered out by an ad generator module and will not be rendered on the search results webpage even though the keyword(s) of the advertisement will match one or more search keywords. In one embodiment, the “Search and Advertisements” is provided as a default option for all users.

FIG. 3B illustrates a search results webpage wherein the user preference specifies “Advertisement only” option. The search results webpage includes a plurality of sponsored advertisements with keywords matching the search parameters 230 provided at the user interface. In one embodiment, the advertisements are identified by matching keywords of the advertisements with one or more search keywords. The identified sponsored advertisements are further based on the ad preference of the respective advertisements matching with the user preference. In the instance where the user preference specifies “Advertisement only”, the ad preference for each of the advertisements being rendered specifies “ON-DEMAND” option. As the user explicitly requests advertisements only, the search results webpage includes only sponsored advertisements. This option provides a greater return-on-investment for an advertiser as there is a higher potential for the advertiser to generate ad income based on user interaction at the advertisement associated with the advertiser. If, on the other hand, the ad preference for an advertisement specifies an “ON-DISPLAY” option, then that advertisement will be filtered out by an ad generator module and will, therefore, not be identified for rendering when the user preference specifies “Advertisement only” option. The advertisement will be filtered out even when the keyword of the advertisement matches one or more search keywords. Thus, appropriate advertisements are identified and rendered based on a match of the user preference with corresponding ad preference of each advertisement.

FIG. 3C illustrates a search results webpage wherein the user preference specifies “Search only” option. The search results webpage, in this embodiment, will only include a plurality of search results 220 matching the search parameters 230 provided at the user interface and identified using a mathematical algorithm that match advertisement keywords with one or more search keywords provided in search parameters. As the user preference explicitly requests search results only, all the sponsored advertisements whose keywords match the search keywords are filtered out by the ad generator module. This option provides flexibility to the user to define the content of the search results webpage, thereby enriching the user's search experience.

The user preference may be updated during the course of searching and rendering of the advertisements on the search results webpage. For instance, if the user interface specifies “Advertisements only” initially, the user preference can be modified to specify either “Search only” or “Search and Advertisements” at any time during the rendering of the advertisement on the search results webpage. The content of the search results webpage will be rendered accordingly, based on a match of the user preference with the ad preference.

Although embodiments of the invention have been described with reference to a search results webpage, it should be understood that the embodiments may be extended to any type of webpage on which an advertisement may be rendered.

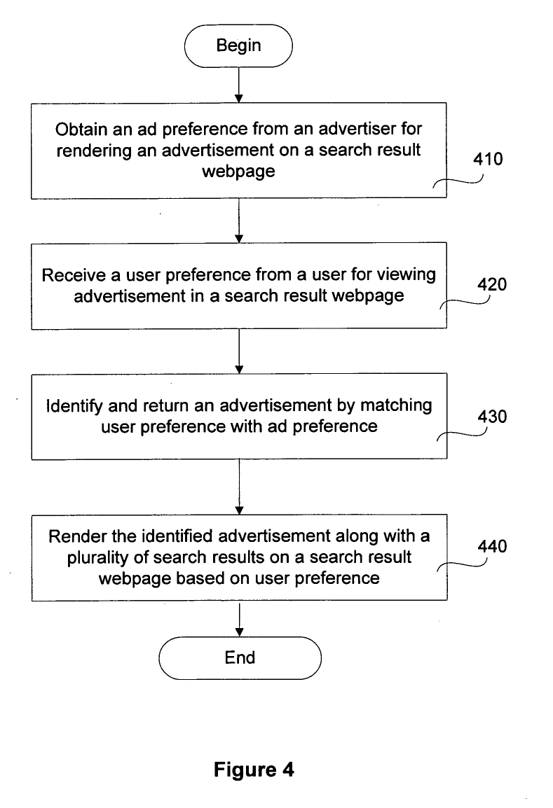

With the above detailed description of the user preference and ad preference, a method for providing advertisement on demand on a search result webpage will now be described with reference to FIG. 4. The method begins at operation 410 when an ad preference for an advertisement is obtained from a user interface. The ad preference may be obtained along with a plurality of advertisement parameters that define advertisement objective for the advertisement. The advertisement parameters are used to book the advertisement using one or more keywords. A descriptive tag that distinctly identifies the ad preference of the advertisement is defined. The descriptive tag is associated with the advertisement and stored along with the advertisement in an ad repository for future mining.

A user preference associated with a user is obtained through a user interface, as illustrated in operation 420. The user preference may be obtained along with a plurality of search parameters used in searching for a product or service. The user preference identifies the viewing intent of a user for viewing advertisements on a search results webpage.

An ad repository is searched and a plurality of advertisements with keywords matching one or more search keywords are identified and returned based on ad preference associated with each advertisement, as illustrated in operation 430. As the ad preference for an advertisement is defined by the sponsorship intent of the advertiser for the advertisement, not all advertisements with keywords that match the search keywords will be identified and returned. The identified advertisements are further filtered based on user preference.

The method concludes with the identified advertisements rendered on a search results webpage based on user preference and a match between the user preference and the ad preference for each of the identified advertisements, as illustrated in operation 440. The identified advertisements are rendered in a format defined by the ad preference and user preference. The rendered advertisements allow optimal promotion of the product/service for the advertiser associated with the advertisement as the identifying and rendering of advertisements is based on an explicit request by a user indicating potential revenue for the advertiser. The user is able to enjoy hassle-free search experience while having the control to view advertisements as and when the user wants.

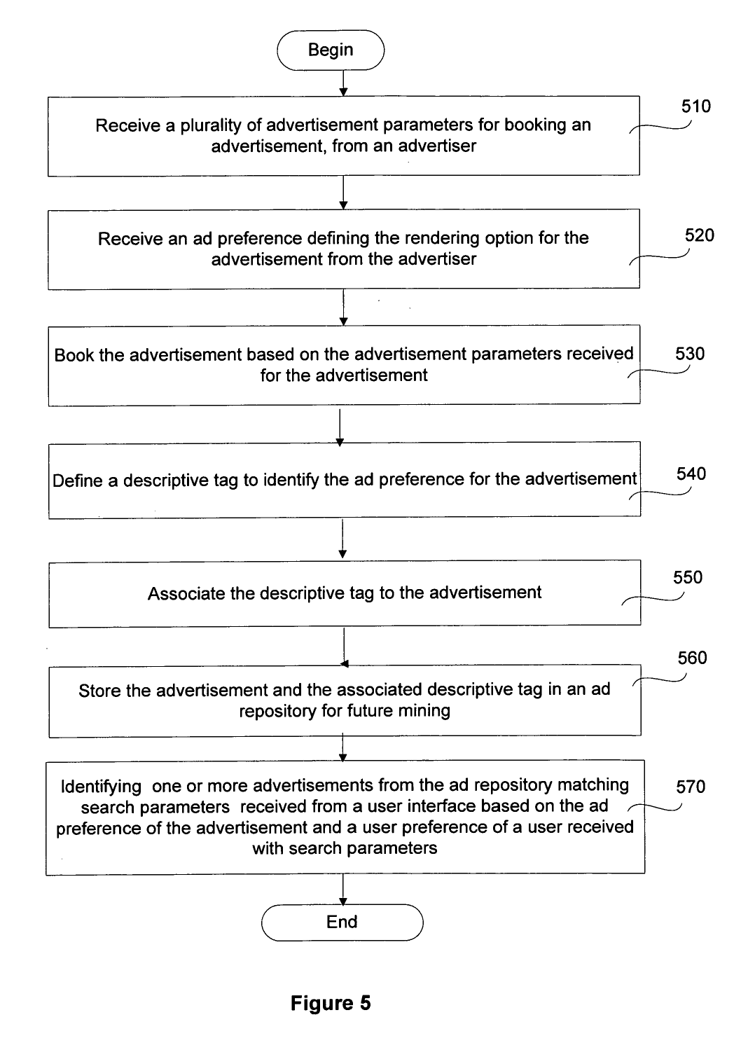

FIG. 5 illustrates process flow operations involved in providing advertisements on demand on a search results webpage. The process begins when a plurality of advertisement parameters are received for booking an advertisement, as illustrated in operation 510. The advertisement parameters describe the advertisement objectives of an advertiser. An ad preference, describing rendering options desired by the advertiser associated with the advertisement, is received, as illustrated in operation 520. In one embodiment, the plurality of advertisement parameters may include an ad preference as one of the advertisement parameters. In another embodiment, the ad preference is separate from the plurality of advertisement parameters. The advertisement parameters are used in booking the advertisement, as illustrated in operation 530. A descriptive tag distinctly describing the ad preference is defined for the advertisement, as illustrated in operation 540. A tag generator module may be used to receive the ad preference, analyze it and define a tag that appropriately reflects the ad preference. The tag generator further associates the tag with the advertisement, as illustrated in operation 550 and returns the tag to the search engine for storing with the advertisement in an ad repository for future mining, as illustrated in operation 560. When a user enters a plurality of search parameters to search for a product or service, one or more of the stored advertisements matching one or more search keywords may be mined and returned for rendering based on a match of the ad preference of each advertisement with the user preference, as illustrated in operation 570. The rendered advertisements have a better click-to-revenue conversion ratio, as there is a higher likelihood of user interaction at these advertisements. This is due to the fact that these advertisements were rendered based on user preference, which indicates potential user interest in these advertisements.

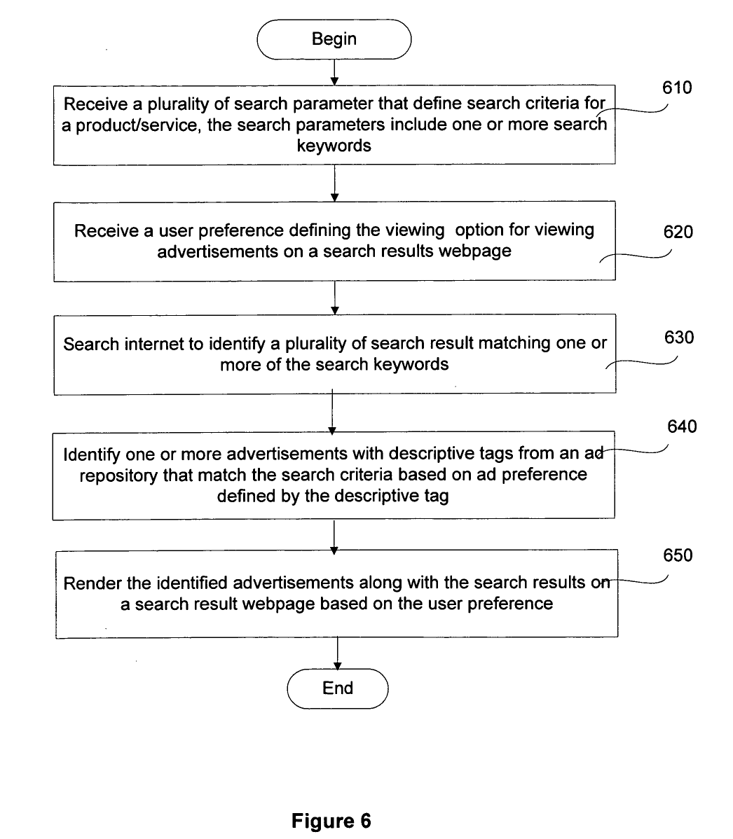

FIG. 6 illustrates process flow operation for providing advertisements on demand on a search results webpage, in another embodiment of the invention. The method begins at operation 610 where a plurality of search parameters is received at a search engine through a user interface. The search parameters define search criteria for a product or service and include one or more search keywords. A user preference defining how a user wants to view search results is received from a user interface at the search engine, as illustrated in operation 620. In one embodiment, the user preference is received as one of the search parameters. The available inventory at the search engine is searched using the search parameters and one or more search results matching the search keywords are identified for rendering, as illustrated in operation 630. An ad repository, including a plurality of advertisements from a plurality of advertisers, is also searched to identify one or more advertisements with keywords matching the one or more search keywords, as illustrated in operation 640. Each of the advertisements is tagged with a descriptive tag that distinctly describes the ad preference defining the rendering option desired by the advertiser for that advertisement. The identified advertisements are filtered based on a match of the associated ad preference with the user preference. The process concludes with the rendering of the identified advertisements and search results on a search results webpage based on user preference, as illustrated in operation 650. Thus, the ad preference for an advertisement is matched with a user preference from a user, to determine if the advertisement should be rendered on a search results webpage or not. The current embodiments provide control to the user to define the content of the search results webpage, thereby enriching the user's search experience. The advertisements, thus rendered, have a better click-to-revenue conversion ratio than the traditional advertisements rendered on the search results webpage.

The rendering of the identified advertisements may be influenced by one or more rendering rules. In one embodiment, the rendering rules may be used to determine the sequence of the rendered advertisements. The advertisements are ranked and prioritized based on the rules and presented at the search results webpage. In one embodiment, the ad generator and interacts with a rendering rules module to obtain a rule for rendering the identified advertisements. The rendering rule may, in one embodiment, include logic to rank and prioritize the advertisements based on an advertisement fee paid by advertisers associated with the advertisements. Advertisement with a higher advertisement fee may be placed at a higher level than an advertisement with a lower advertisement fee. The search engine, upon receipt of the rule for rendering, ranks and prioritizes the identified advertisements and transmits the sequence with the advertisements for rendering on the search results webpage. The rendering rules may be pre-set by a search engine host at the time each of the advertisements are booked.

Thus, embodiments of the invention provide a tool for rendering advertisements on demand in a search results webpage. The rendered advertisements provide optimal promotion of the product/service for the advertiser associated with the advertisement as the advertisements are rendered specifically upon user request strongly indicating user interest in these advertisements. The advertiser has more control in determining how each advertisement is rendered, thereby avoiding fraudulent and/or inadvertent user interactions at the advertisements that unnecessarily consume an advertiser's advertisement budget. The rendered advertisements provide better search experience for a user as the user has more control in the rendering of the advertisement. The tool provides greater flexibility to the user for viewing the advertisement by enabling user preferences to be updated at any time during the search process.

The present invention may be used to provide advertisement metrics for an advertiser, so that the advertiser may be able to further optimize the advertisement for better return on investment. The advertiser may be able to obtain advertisement metrics based on interaction at the advertisements, such as click-through, double click, etc., to determine the effectiveness of the advertisement. A host of a search engine may also be able to use the advertisement metrics to determine monetization for each advertisement.

It will be obvious, however, to one skilled in the art, that the present invention may be practiced without some or all of these specific details. In other instances, well known process operations have not been described in detail in order not to unnecessarily obscure the present invention.

Embodiments of the present invention may be practiced with various computer system configurations including hand-held devices, microprocessor systems, microprocessor-based or programmable consumer electronics, minicomputers, mainframe computers and the like. The invention can also be practiced in distributed computing environments where tasks are performed by remote processing devices that are linked through a wire-based or wireless network.

With the above embodiments in mind, it should be understood that the invention can employ various computer-implemented operations involving data stored in computer systems. These operations are those requiring physical manipulation of physical quantities. Usually, though not necessarily, these quantities take the form of electrical or magnetic signals capable of being stored, transferred, combined, compared and otherwise manipulated.

Any of the operations described herein that form part of the invention are useful machine operations. The invention also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can thereafter be read by a computer system. The computer readable medium can also be distributed over a network-coupled computer system so that the computer readable code is stored and executed in a distributed fashion.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for providing advertisement on demand on a search results webpage, comprising:
receiving an ad preference for the advertisement, the ad preference defining rendering option desired by an advertiser for the advertisement;
receiving a user preference for viewing an advertisement on the search webpage;
searching an ad repository to identify an advertisement that matches the ad preference with the user preference, the ad repository having a plurality of advertisements from a plurality of advertisers; and
rendering the identified advertisement on the search results webpage in a format defined by the ad preference and user preference, the rendering allowing optimal promotion of a product or service associated with the advertisement.

2. The method of claim 1, wherein receiving an ad preference further including, receiving a plurality of advertisement parameters for booking the advertisement, the advertisement parameters including one or more keywords to define the advertisement objective of the advertiser, wherein the plurality of advertisement parameters includes the ad preference for rendering the advertisement on the webpage;
defining a descriptive tag for the ad preference;
associating the descriptive tag to the advertisement upon booking the advertisement, the descriptive tag distinctly identifying the ad preference associated with the advertisement; and
storing the descriptive tag along with the plurality of advertisement parameters associated with the advertisement in the ad repository for future mining.

3. The method of claim 2, wherein the user preference is received with a plurality of search parameters defining search criteria for a product or service, the search criteria including one or more search keywords.

4. The method of claim 3, wherein searching the ad repository further including, searching the ad repository using search keywords to identify one or more advertisements that match the search keywords;
selecting one or more of the identified advertisements based on a match of the descriptive tag with user preference; and
returning the identified advertisements for rendering based on the user preference.

5. The method of claim 4, wherein the advertisement is a sponsored advertisement, wherein the sponsored advertisement is defined by an advertisement budget provided by an advertiser.

6. The method of claim 5, wherein the ad preference is one of an on-demand option or an on-display option, wherein the on-demand option allows for only sponsored ads to be rendered on the search results webpage and the on-display option allows for sponsored ads to be rendered along with one or more search results matching the search parameters on the search results webpage.

7. The method of claim 6, wherein the user preference includes one of search only option, search and advertisement option or advertisement only option, wherein the search only option includes only search results, the search and advertisement option includes search results and sponsored advertisements and advertisements only option includes only sponsored advertisements.

8. The method of claim 7, further including determining monetization for an advertisement, the monetization based on type of ad preference defined by the advertiser.

9. The method of claim 8, wherein the advertisement is customized based on geo-location of a user.

10. The method of claim 1, wherein the user preference is updated at any time during a search process.

11. A system for providing advertisement on demand on a search results webpage, comprising:
a user interface at a client to receive an ad preference identifying rendering option for an advertisement and a user preference identifying viewing option to view the advertisement on the search results webpage; and
a search engine on a server communicatively connected to the user interface to receive the ad preference for an advertisement and user preference for viewing the advertisement from the user interface;
a tag generator on the server communicatively connected to the search engine and configured to receive the ad preference for an advertisement and define a descriptive tag for the advertisement, the descriptive tag distinctly identifying the ad preference for the advertisement;
an ad generator on the server communicatively connected to the search engine and configured to,
receive the user preference from the user interface for viewing the advertisement;
identify the advertisement from an ad repository that matches the user preference with the descriptive tag defining the ad preference of the advertisement; and
return the identified advertisement for rendering on the search results webpage in a format defined by the ad preference and the user preference, the returned advertisement allowing optimal promotion of a product or service associated with the advertisement.

12. The system of claim 11, wherein the server further including an ad repository for storing a plurality of advertisements and descriptive tag for each advertisement.

13. The system of claim 12, wherein the server further including a search link repository to store one or more search results, the search results obtained by matching the search parameters with inventory available at the search engine.

14. The system of claim 13, wherein the search link repository is integrated with the ad repository.

15. The system of claim 11, wherein the tag generator is integrated with the ad generator.

16. The system of claim 15, wherein the ad generator is integrated with the search engine.

17. A method for providing an advertisement on demand on a search results webpage, comprising:
receiving a user preference for viewing an advertisement on the search webpage;
searching an ad repository to identify a plurality of advertisements that match the user preference, the ad repository having a plurality of advertisements from a plurality of advertisers, each of the plurality of advertisements in the ad repository tagged with a descriptive tag that defines an ad preference for the advertisement, the ad preference defining a rendering option for each advertisement defined by an advertiser associated with the advertisement, wherein matching of the user preference is matching the user preference with the ad preference of the advertiser; and
rendering the identified advertisements on the search results webpage along with search results in a format defined by the ad preference and the user preference, the rendering allowing optimal promotion of a product or service associated with the advertisement.

18. The method of claim 17, wherein the user preference is received along with one or more search parameters defining search criteria for a product or service, the search criteria including one or more search keywords.

19. The method of claim 18, wherein searching an ad repository further including, searching the ad repository using search keywords to identify one or more advertisements that match the search keywords;
selecting one or more of the identified advertisements based on a match of the descriptive tag with user preference; and
returning the selected advertisements along with one or more search results matching the search keywords for rendering on the search results webpage.

20. The method of claim 19, wherein the advertisements are sponsored advertisements, wherein the sponsored advertisements are defined by an advertisement budget provided by an advertiser.

21. The method of claim 20, wherein the ad preference is one of an on-demand option or a on-display option, wherein the on-demand option allowing for only sponsored ads to be rendered on the search results webpage and the on-display option allows for sponsored ads to be rendered with search results on the search results webpage.
